(19) United States
(12) Patent Application Publication
(10) Pub. No.: US 2025/0192367 A1
(43) Pub. Date: Jun. 12, 2025

(54) MULTI-LAYER SEPARATOR FOR LITHIUM-ION BATTERY

(71) Applicant: FORD GLOBAL TECHNOLOGIES, LLC, Dearborn, MI (US)

(72) Inventors: Jonghwan PARK, Ann Arbor, MI (US); Insik JEON, Novi, MI (US)

(21) Appl. No.: 18/537,147

(22) Filed: Dec. 12, 2023

(51) Int. Cl. H01M 50/457; B60L 50/64; H01M 10/0525; H01M 50/403; H01M 50/426; H01M 50/434; H01M 50/451; H01M 50/46; H01M 50/497

(52) U.S. Cl. CPC H01M 50/457; H01M 10/0525; H01M 50/403; H01M 50/426; H01M 50/434; H01M 50/451; H01M 50/46; H01M 50/497; B60L 50/64; H01M 2220/20

(57) ABSTRACT

A separator of a lithium-ion battery cell includes a porous separator film, an inner layer disposed against the separator film and including ceramic filler, and an outer layer disposed against the inner layer and including ferroelectric material configured to facilitate lithium-ionic conductivity between the separator and an electrode.

### TECHNICAL FIELD

This disclosure relates to vehicle traction batteries and more particularly to porous separators used in lithium-ion batteries.

### BACKGROUND

Powertrain electrification is used by automakers to improve fuel economy. These systems can have higher electrical ratings and have high- and low-voltage components. The powertrain may include an electric machine powered by a traction battery and/or an engine in the case of a hybrid. The battery may have lithium-ion chemistry.

### SUMMARY

According to an embodiment, a separator of a lithium-ion battery cell includes a porous separator film, an inner layer disposed against the separator film and including ceramic filler, and an outer layer disposed against the inner layer and including ferroelectric material configured to facilitate lithium-ionic conductivity between the separator and an electrode.

In one or more embodiments, the inner layer is thicker than the outer layer, and the film is thicker than the inner layer. The inner layer may be at least twice as thick as the outer layer. The inner layer may have a thickness of 1.0 to 5.0 microns, and the outer layer may have a thickness of 0.1 to 2.0 microns. The ferroelectric material may include one or more of polyvinylidene fluoride (PVDF), lead titanate (PbTiO3), lead zirconate titanate (PZT), lead lanthanum zirconate titanate (PLZT), barium titanate (BaTiO3), Rochelle salt, KNbO3, CdNb2O6, PbNb2O6, PbTa2O6, PbBi2Nb2O9, or lead magnesium niobate (PMN). The ceramic filler may include one or more of Al2O3, AlOOH, Al(OH)3, TiO2, ZrO2, Y2O3, Yttria stabilized Zirconia (YSZ), Dy2O3, Gd2O3, CeO2, GDC (Gadolinia doped Ceria), MgO, NiMn2O4, BiKTiO3, BiFeO3, Bi1.5Zn1Nb1.5O7, WO, SnO2, LSMO, LSFC, AlN, SiN, SiO2, ZnO, HfO2, TiN, SiC, TiC, WC, MgB, TiB, CaO, CoFe2O4, NiFe2O4, BaFe2O4, NiZnFe2O4, ZnFe2O4, or MnxCo3-xO4.

The separator may have a second inner layer disposed against the separator film and including ceramic filler; and a second outer layer disposed against the inner layer and including ferroelectric material configured to facilitate lithium-ionic conductivity between the separator and an electrode.

According to another embodiment, a lithium-ion battery cell includes an anode, a cathode, and a separator disposed between the anode and the cathode. The separator may include a porous separator film, a first inner layer disposed against the separator film and including ceramic filler, and a first outer layer having an inner side disposed against the first inner layer and an outer side disposed against the anode or cathode, the first outer layer including ferroelectric material.

According to yet another embodiment, a method of forming a separator of a battery cell includes placing an inner layer containing ceramic filler on a first side of a porous separator film; and placing an outer layer containing ferroelectric material on the inner layer to facilitate lithium-ionic conductivity with an electrode, wherein the inner layer is thicker than the outer layer.

### BRIEF DESCRIPTION OF THE DRAWINGS

FIG. 1 is a schematic diagram of an electric vehicle.

FIG. 2 is a schematic drawing of a lithium-ion battery.

FIG. 3 is a schematic drawing of a separator of the battery.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

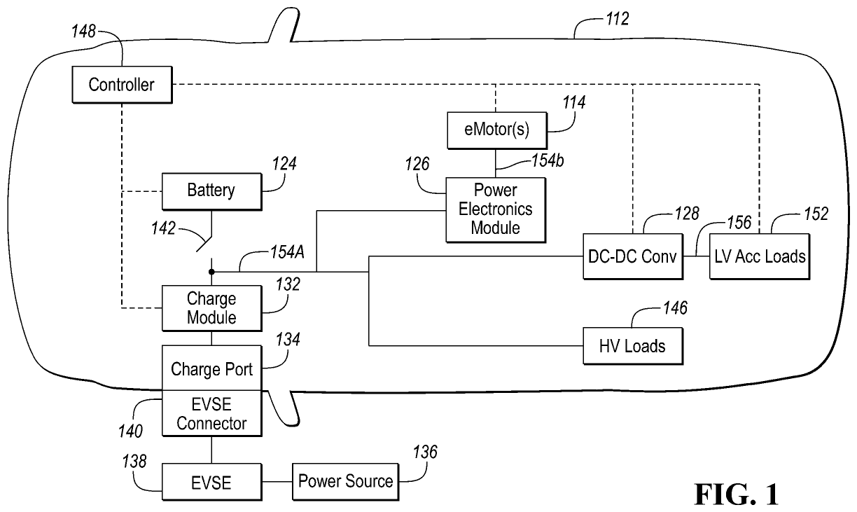

FIG. 1 depicts an electric vehicle 112. The vehicle 112 includes an electrified propulsion system having one or more electric machines 114 mechanically coupled to driven wheels. The electric machines 114 may be capable of operating as a motor or a generator. The electric machines 114 are arranged to provide propulsion torque as well braking. The electric machines 114 can operate as generators providing fuel economy benefits by recovering energy that would otherwise be lost as heat in a friction-braking system.

A traction battery or battery pack 124 stores energy that can be used to power the electric machines 114. The battery pack 124 may provide a high-voltage direct current (DC) output. The battery 124 includes an electrical distribution system (EDS) 118 that carries power from the cells to loads and vice versa. Portions of the EDS 118 may be components of the battery 124 and other portions may be external to the battery 124. One or more contactors 142 may isolate the traction battery 124 from a DC high-voltage bus 154A when open and may couple the traction battery 124 to the DC high-voltage bus 154A when closed. The traction battery 124 is electrically coupled to one or more power electronics modules 126 via the DC high-voltage bus 154A. The power electronics module 126 is also electrically coupled to the electric machines 114 and provides the ability to bi-directionally transfer energy between AC high-voltage bus 154B and the electric machines 114. According to some examples, the traction battery 124 may provide a DC current while the electric machines 114 operate using a three-phase alternating current (AC). The power electronics module 126 may convert the DC current to a three-phase AC current to operate the electric machines 114. In a regenerative mode, the power electronics module 126 may convert the three-phase AC current output from the electric machines 114 acting as generators to DC current compatible with the traction battery 124.

In addition to providing energy for propulsion, the traction battery 124 may provide energy for other vehicle electrical systems. The vehicle 112 may include a DC/DC converter module 128 that is electrically coupled to the high-voltage bus 154. The DC/DC converter module 128 may be electrically coupled to a low-voltage bus 156. The DC/DC converter module 128 may convert the high-voltage DC output of the traction battery 124 to a low-voltage DC supply that is compatible with low-voltage vehicle loads 152. The low-voltage bus 156 may be electrically coupled to an auxiliary battery 130 (e.g., 12V battery). The low-voltage loads 152 may be electrically coupled to the low-voltage bus 156. The low-voltage loads 152 may include various controllers within the vehicle 112.

The traction battery 124 of vehicle 112 may be recharged by an off-board power source 136. The off-board power source 136 may be a connection to an electrical outlet. The external power source 136 may be electrically coupled to a charger or another type of electric vehicle supply equipment (EVSE) 138. The off-board power source 136 may be an electrical power distribution network or grid as provided by an electric utility company. The EVSE 138 provides circuitry and controls to regulate and manage the transfer of energy between the power source 136 and the vehicle 112. The off-board power source 136 may provide DC or AC electric power to the EVSE 138. The EVSE 138 includes a charge connector 140 for plugging into a charge port 134 of the vehicle 112. The charge port 134 may be any type of port configured to transfer power from the EVSE 138 to the vehicle 112. The charge port 134 may be electrically coupled to a charge module or on-board power conversion module 132. The power conversion module 132 conditions power supplied from the EVSE 138 to provide the proper voltage and current levels to the traction battery 124. The power conversion module 132 interfaces with the EVSE 138 to coordinate the delivery of power to the vehicle 112. The EVSE connector 140 may have pins that mate with corresponding recesses of the charge port 134. Alternatively, various components described as being electrically coupled or connected may transfer power using wireless inductive coupling or other non-contact power transfer mechanisms. The charge components including the charge port 134, power conversion module 132, power electronics module 126, and DC-DC converter module 128 may collectively be considered part of a power interface system configured to receive power from the off-board power source 136.

When the vehicle 112 is plugged in to the EVSE 138, the contactors 142 may be in a closed state so that the traction battery 124 is coupled to the high-voltage bus 154 and to the power source 136 to charge the battery. The vehicle may be in the ignition-off condition when plugged in to the EVSE 138.

One or more wheel brakes (not shown) may be provided as part of a braking system to slow the vehicle 112 and prevent rotation of the vehicle wheels. The brakes may be hydraulically actuated, electrically actuated, or some combination thereof. The brake system may also include other components to operate the wheel brakes. The brake system may include a controller to monitor and coordinate operation. The controller monitors the brake system components and controls the wheel brakes 144 for vehicle deceleration. The brake system also responds to driver commands via a brake pedal input and may also operate to automatically implement features such as stability control. The controller of the brake system may implement a method of applying a requested brake force when requested by another controller or sub-function.

One or more high-voltage electrical loads 146 may be coupled to the high-voltage bus 154. The high-voltage electrical loads 146 may have an associated controller that operates and controls the high-voltage electrical loads 146 when appropriate. The high-voltage loads 146 may include components such as compressors and electric heaters.

The various components discussed may have one or more associated controllers to control, monitor, and coordinate the operation of the components. The controllers may communicate via a serial bus (e.g., Controller Area Network (CAN)) or via discrete conductors. In addition, a vehicle system controller 148 may be provided to coordinate the operation of the various components.

While illustrated as one controller, the controller may be part of a larger control system and may be controlled by various other controllers throughout the vehicle 112, such as a vehicle system controller (VSC). It should therefore be understood that the controller and one or more other controllers can collectively be referred to as a “controller” that controls various actuators in response to signals from various sensors to control functions. The controller may include a microprocessor or central processing unit (CPU) in communication with various types of computer-readable storage devices or media. Computer-readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller in controlling the vehicle. The controller communicates with various vehicle sensors and actuators via an input/output (I/O) interface that may be implemented as a single integrated interface that provides various raw data or signal conditioning, processing, and/or conversion, short-circuit protection, and the like. Alternatively, one or more dedicated hardware or firmware chips may be used to condition and process particular signals before being supplied to the CPU.

In one embodiment, a system controller 148, although represented as a single controller, may be implemented as one or more controllers, may monitor operating conditions of the various vehicle components. According to the example of FIG. 1, at least the electric machines 114, the EDS 118, the traction battery 124, the DC-DC converter 128, the charging module 132, the high-voltage loads 146, and low-voltage loads 152 are in communication with the controller 148. The traction battery 124 also includes a current sensor to sense current that flows through the traction battery 124. The traction battery 124 also includes a voltage sensor to sense a voltage across terminals of the traction battery 124. The voltage sensor outputs a signal indicative of the voltage across the terminals of the traction battery 124. The traction battery current sensor outputs a signal indicative of a magnitude and direction of current flowing into or out of the traction battery 124.

The charging module 132 also includes a current sensor to sense current that flows from the EVSE 138 to the traction battery 124. The current sensor of the charging module 132 outputs a signal indicative of a magnitude and direction of current flowing from the EVSE 138 to the traction battery 124.

The current sensor and voltage sensor outputs of the traction battery 124 are provided to the controller 148. The controller 148 may be programmed to compute a state of charge (SOC) based on the signals from the current sensor and the voltage sensor of the traction battery 124. Various techniques may be utilized to compute the state of charge. For example, an ampere-hour integration may be implemented in which the current through the traction battery 124 is integrated over time. The SOC may also be estimated based on the output of the traction battery voltage sensor 104. The specific technique utilized may depend upon the chemical composition and characteristics of the particular battery.

The controller 148 may also be configured to monitor the status of the traction battery 124. The controller 148 includes at least one processor that controls at least some portion of the operation of the controller 148. The processor allows onboard processing of commands and executes any number of predetermined routines. The processor may be coupled to non-persistent storage and persistent storage. In an illustrative configuration, the non-persistent storage is random access memory (RAM) and the persistent storage is flash memory. In general, persistent (non-transitory) storage can include all forms of storage that maintain data when a computer or other device is powered down.

A desired SOC operating range may be defined for the traction battery 124. The operating ranges may define an upper and lower limit at which the SOC of the battery 124 is bounded. During vehicle operation, the controller 148 may be configured to maintain the SOC of the battery 124 within the desired operating range. In other cases, the battery is recharged when at rest and connected to an off-board power source. Based on a rate of battery depletion and/or recharge, charging of the traction battery may be scheduled in advance based on approaching an SOC low threshold. The timing and rate of recharging may also be opportunistically selected to maintain voltage and SOC within predetermined ranges.

While not shown, the vehicle 112 includes an accelerator pedal that enables the driver to request torque. The vehicle may be programmed to determine a driver-demanded torque based on a position of the accelerator pedal and vehicle speed. The driver-demanded torque may be a raw wheel torque that is commanded by the driver and is used to control the torque produced by the motors 114.

The above-described vehicle example is but one application for the below described battery. It is to be understood that the battery 100 may be used in any suitable application including vehicles as described above.

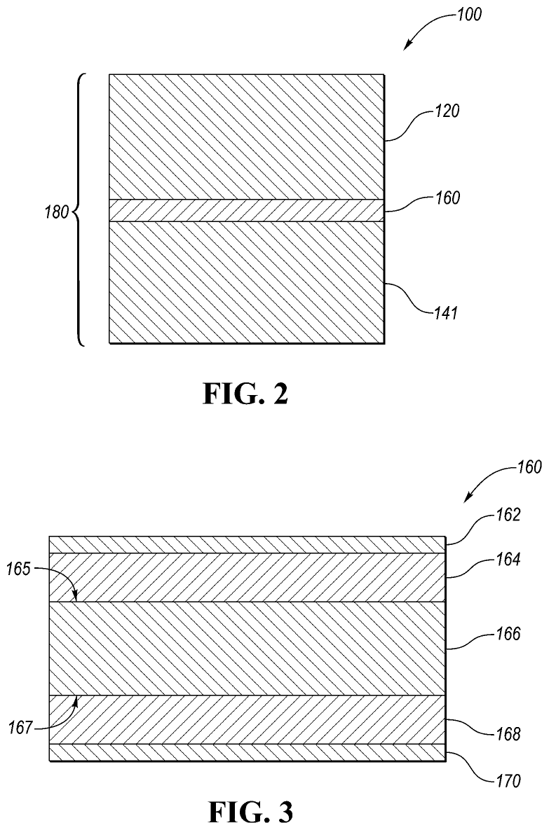

Referring to FIG. 2, the battery 100 is illustrated, for example, as lithium-ion (Li-ion) battery. The battery 100 has a negative electrode (anode) 120, a positive electrode (cathode) 141, and a separator 160 disposed between the anode 120 and cathode 141. The anode may contain hard carbon, the graphite-like carbon, including natural and artificial graphite, metal mixed oxide (lithium metal), and lithium alloy (a silicon group alloy may be used as the anodal active material).

The separator 160 may be formed of any suitable material. In at least one embodiment, the separator 160 includes a polyolefin, such as polyethylene or polypropylene. The separator 160 will be discussed in detail below. An electrolyte 180 may be disposed within the battery cell to be in contact with anode 120, cathode 141, and/or separator 160. In at least one embodiment, the electrolyte includes a lithium salt and an organic solvent. Examples of suitable lithium salts include, but are not limited to, LiPF6, LiBF4 and LiClO4. The organic solvent may include ethylene carbonate (EC), dimethyl carbonate (DMC), and/or diethyl carbonate (DEC), and any combination thereof, as well as other suitable organic solvents. In at least one embodiment, the organic solvent is a combination of EC and DEC in a 3:7 ratio by volume (v/v). Other suitable electrolytes may include ionic liquid electrolytes and aqueous electrolytes.

A typical ceramic-coated layer on a porous separator only enhances mechanical strength the lithium-ion battery. The separators proposed herein have multi-functional composite layers thus increasing ionic conductivity between a surface of the outer coated layer and anode (and/or cathode) for low cell resistance and more efficient ion transfer through pores of the separator.

Referring to FIG. 3, the porous separator 160 includes multi-functional composite layers having different properties to improve lithium-ionic conductivity in the interfacial region and for thermal/mechanical stability, oxidation protection, electrolyte wetting/reservoir, and Lithium-ion conductive layer double coated on the surface of the anode direction to maximize the conductivity effect. The separator 160 also improves ionic conductivity between the surface of coated layer and the anode for low cell resistance together.

Outer and inner layers 162, 164 are applied to first side 165 a porous separator film 166. The outer layer 162 is a lithium-ion conductive layer, and the inner layer 164 is for thermal/mechanical stability, oxidation protection, and electrolyte wetting/reservoir. These multi-functional composite layers provide different function to increase lithium-ionic conductivity in the interfacial region (between surface of coated layer and anode intensively for low cell resistance) and for thermal/mechanical stability, oxidation protection, electrolyte wetting/reservoir, and Lithium-ion conductive layer double coated on the surface of any anode direction to maximize the conductivity effect.

The outer layer 162 contains ferroelectric materials including but not limited to: polyvinylidene fluoride (PVDF) and its copolymers, lead titanate (PbTiO3), lead zirconate titanate (PZT), lead lanthanum zirconate titanate (PLZT), barium titanate (BaTiO3), Rochelle salt, KNbO3, CdNb2O6, PbNb2O6, PbTa2O6, PbBi2Nb2O9, and lead magnesium niobate (PMN), etc.

The outer layer may 162 may include only one of the above-listed materials or may include a combination of the above-listed materials.

The inner layer 164 contains ceramic fillers including but not limited to: Al2O3, AlOOH, Al(OH)3, TiO2, ZrO2, Y2O3, YSZ (Yttria stabilized Zirconia), Dy2O3, Gd2O3, CeO2, GDC(Gadolinia doped Ceria), MgO, NiMn2O4, BiKTiO3, BiFeO3, Bi1.5Zn1Nb1.5O7, WO, SnO2, LSMO, LSFC, AlN, SiN, SiO2, ZnO, HfO2, TiN, SiC, TiC, WC, MgB, TiB, CaO, CoFe2O4, NiFe2O4, BaFe2O4, NiZnFe2O4, ZnFe2O4, MnxCo3-xO4. The inner layer may 164 may include only one of the above-listed materials or may include a combination of the above-listed materials.

The outer layer 162 is thinner than the inner layer 164. The inner layer 164 may be at least twice as thick as the outer layer 162. For example, the outer layer 162 may have a thickness of 0.1-2 micros (inclusive) and the inner layer 164 may have a thickness of 1-5 microns (inclusive). The separator film 166 is thicker than the layers 162 and 164 with an example thickness of 3-30 microns, inclusive.

In some embodiments, inner and outer layers are only provided one side of the separator film, however, in other embodiments, they are applied to both sides, as shown in FIG. 3. In yet another embodiment, the separator includes the inner and outer layers on only one side of the separator, and the other side includes just a ceramic layer, e.g., the same or similar to layer 164.

Referring back to FIG. 3, a second outer layer 170 and a second inner layer 168 are applied to the second side 167 of the separator film 166. This is to be understood as only one example embodiment. Both the individual thicknesses and the relative thicknesses of the layers 168/170 may be as described above.

The layer 170 contains ferroelectric materials including but not limited to: polyvinylidene fluoride (PVDF) and its copolymers, lead titanate (PbTiO3), lead zirconate titanate (PZT), lead lanthanum zirconate titanate (PLZT), barium titanate (BaTiO3), Rochelle salt, KNbO3, CdNb2O6, PbNb2O6, PbTa2O6, PbBi2Nb2O9, and lead magnesium niobate (PMN), etc. The outer layer may 162 may include only one of the above-listed materials or may include a combination of the above-listed materials.

The inner layer 168 contains ceramic fillers including but not limited to: Al2O3, AlOOH, Al(OH)3, TiO2, ZrO2, Y2O3, YSZ (Yttria stabilized Zirconia), Dy2O3, Gd2O3, CeO2, GDC(Gadolinia doped Ceria), MgO, NiMn2O4, BiKTiO3, BiFeO3, Bi1.5Zn1Nb1.5O7, WO, SnO2, LSMO, LSFC, AlN, SiN, SiO2, ZnO, HfO2, TiN, SiC, TiC, WC, MgB, TiB, CaO, CoFe2O4, NiFe2O4, BaFe2O4, NiZnFe2O4, ZnFe2O4, MnxCo3-xO4. The inner layer may 164 may include only one of the above-listed materials or may include a combination of the above-listed materials.

In some embodiments, the layers 162 and 170 have the same composition, but in others, they may differ by using different combinations of the above-described compounds. The same is true of the inner layers 164/168.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A separator of a lithium-ion battery cell comprising:
a porous separator film;
an inner layer disposed against the separator film and including ceramic filler; and
an outer layer disposed against the inner layer and including ferroelectric material configured to facilitate lithium-ionic conductivity between the separator and an electrode.

2. The separator of claim 1, wherein the inner layer is thicker than the outer layer, and the film is thicker than the inner layer.

3. The separator of claim 2, wherein the inner layer is at least twice as thick as the outer layer.

4. The separator of claim 2, wherein the inner layer has a thickness of 1.0 to 5.0 microns, and the outer layer has a thickness of 0.1 to 2.0 microns.

5. The separator of claim 1, wherein the ferroelectric material includes one or more of polyvinylidene fluoride (PVDF), lead titanate (PbTiO3), lead zirconate titanate (PZT), lead lanthanum zirconate titanate (PLZT), barium titanate (BaTiO3), Rochelle salt, KNbO3, CdNb2O6, PbNb2O6, PbTa2O6, PbBi2Nb2O9, or lead magnesium niobate (PMN).

6. The separator of claim 5, wherein the ceramic filler includes one or more of Al2O3, AlOOH, Al(OH)3, TiO2, ZrO2, Y2O3, Yttria stabilized Zirconia (YSZ), Dy2O3, Gd2O3, CeO2, GDC(Gadolinia doped Ceria), MgO, NiMn2O4, BiKTiO3, BiFeO3, Bi1.5Zn1Nb1.5O7, WO, SnO2, LSMO, LSFC, AlN, SiN, SiO2, ZnO, HfO2, TiN, SiC, TiC, WC, MgB, TiB, CaO, CoFe2O4, NiFe2O4, BaFe2O4, NiZnFe2O4, ZnFe2O4, or MnxCo3-xO4.

7. The separator of claim 6 further comprising:
a second inner layer disposed against the separator film and including ceramic filler; and
a second outer layer disposed against the inner layer and including ferroelectric material configured to facilitate lithium-ionic conductivity between the separator and an electrode.

8. The separator of claim 7, wherein the inner layer is thicker than the outer layer and the film is thicker than the inner layer, wherein the second inner layer is thicker than the second outer layer, and the film is thicker than the second inner layer.

9. The separator of claim 8, wherein the ferroelectric material of each of the outer layers includes one or more of polyvinylidene fluoride (PVDF), lead titanate (PbTiO3), lead zirconate titanate (PZT), lead lanthanum zirconate titanate (PLZT), barium titanate (BaTiO3), Rochelle salt, KNbO3, CdNb2O6, PbNb2O6, PbTa2O6, PbBi2Nb2O9, or lead magnesium niobate (PMN).

10. The separator of claim 9, wherein the ceramic fillers of the inner layers each includes one or more of Al2O3, AlOOH, Al(OH)3, TiO2, ZrO2, Y2O3, Yttria stabilized Zirconia (YSZ), Dy2O3, Gd2O3, CeO2, GDC (Gadolinia doped Ceria), MgO, NiMn2O4, BiKTiO3, BiFeO3, Bi1.5Zn1Nb1.5O7, WO, SnO2, LSMO, LSFC, AlN, SiN, SiO2, ZnO, HfO2, TiN, SiC, TiC, WC, MgB, TiB, CaO, CoFe2O4, NiFe2O4, BaFe2O4, NiZnFe2O4, ZnFe2O4, or MnxCo3-xO4.

11. A lithium-ion battery cell comprising:
an anode;
a cathode; and
a separator disposed between the anode and the cathode, the separator including:
a porous separator film,
a first inner layer disposed against the separator film and including ceramic filler, and
a first outer layer having an inner side disposed against the first inner layer and an outer side disposed against the anode or cathode, the first outer layer including ferroelectric material.

12. The battery cell of claim 11, wherein the separator further includes:
a second inner layer disposed against the separator film and including ceramic filler; and
a second outer layer having an inner side disposed against the second inner layer and an outer side disposed against the other of the anode or cathode, the second outer layer including ferroelectric material.

13. The battery cell of claim 12, wherein each of the inner layers has a thickness of 1.0 to 5.0 microns, and each of the outer layer has a thickness of 0.1 to 2.0 microns.

14. The battery cell of claim 12, wherein the ferroelectric material of each of the outer layers includes one or more of polyvinylidene fluoride (PVDF), lead titanate (PbTiO3), lead zirconate titanate (PZT), lead lanthanum zirconate titanate (PLZT), barium titanate (BaTiO3), Rochelle salt, KNbO3, CdNb2O6, PbNb2O6, PbTa2O6, PbBi2Nb2O9, or lead magnesium niobate (PMN).

15. The battery cell of claim 11, wherein the first inner layer is at least twice as thick as the first outer layer.

16. The battery cell of claim 11, wherein the ferroelectric material includes one or more of polyvinylidene fluoride (PVDF), lead titanate (PbTiO3), lead zirconate titanate (PZT), lead lanthanum zirconate titanate (PLZT), barium titanate (BaTiO3), Rochelle salt, KNbO3, CdNb2O6, PbNb2O6, PbTa2O6, PbBi2Nb2O9, or lead magnesium niobate (PMN).

17. The battery cell of claim 16, wherein the ceramic filler includes one or more of Al2O3, AlOOH, Al(OH)3, TiO2, ZrO2, Y2O3, Yttria stabilized Zirconia (YSZ), Dy2O3, Gd2O3, CeO2, GDC(Gadolinia doped Ceria), MgO, NiMn2O4, BiKTiO3, BiFeO3, Bi1.5Zn1Nb1.5O7, WO, SnO2, LSMO, LSFC, AlN, SiN, SiO2, ZnO, HfO2, TiN, SiC, TiC, WC, MgB, TiB, CaO, CoFe2O4, NiFe2O4, BaFe2O4, NiZnFe2O4, ZnFe2O4, or MnxCo3-xO4.

18. The battery cell of claim 17, wherein the inner layer has a thickness of 1.0 to 5.0 microns, and the outer layer has a thickness of 0.1 to 2.0 microns.

19. A method of forming a separator of a battery cell, the method comprising:
placing an inner layer containing ceramic filler on a first side of a porous separator film; and
placing an outer layer containing ferroelectric material on the inner layer to facilitate lithium-ionic conductivity with an electrode, wherein the inner layer is thicker than the outer layer.

20. The method of claim 19, wherein the ferroelectric material includes one or more of polyvinylidene fluoride (PVDF), lead titanate (PbTiO3), lead zirconate titanate (PZT), lead lanthanum zirconate titanate (PLZT), barium titanate (BaTiO3), Rochelle salt, KNbO3, CdNb2O6, PbNb2O6, PbTa2O6, PbBi2Nb2O9, or lead magnesium niobate (PMN).
